(19) United States
(12) Patent Application Publication
(10) Pub. No.: US 2011/0056827 A1
(43) Pub. Date: Mar. 10, 2011

(54) ELECTRODE ASSEMBLY

(76) Inventor: Adam Michael Danischewski, Lake Ariel, PA (US)

(21) Appl. No.: 12/557,173

(22) Filed: Sep. 10, 2009

(51) Int. Cl. C25B 11/00; C25B 9/02; B23P 17/04

(52) U.S. Cl. 204/286.1; 204/297.01; 29/464

(57) ABSTRACT

An electrode assembly comprising of a plurality of planar electrodes and rods axially ringed with pairs of washer-style fasteners and washer-style spacers, held on the rod by fasteners on the distal ends. Electrode gap spacing is provided by distancing spacers placed along the rod axis in-between pairs of the washer-style fasteners. The electrode assembly is formed by sliding the proximal electrodes edges in-between pairs of the washer-style fasteners and tightening the end fasteners on the rods, which in turn clamps a portion of each proximal electrode edge holding the electrodes together in parallel under compression. At least two rod subassemblies are configured as charging buses of distinct polarity providing their respective monopolar charge to at least two planar electrodes in the assembly. Monopolar charge is provided to a planar electrode by varying the washer-style fastener pairs on the rod subassemblies from electrically-conductive to electrically-insulating types.

### CROSS-REFERENCE TO RELATED APPLICATIONS

Not Applicable.

### FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present invention relates to an electrode assembly, methods of constructing an electrode assembly and more particularly a robust, inexpensive, compact and easily configurable planar electrode assembly for use in electrolytic cells. Including, but not limited to, an electrode assembly for use in water decomposition apparatuses for production of detonating gas.

2. Discussion of the Related Art

Electrolytic cells contain at least one electrode assembly. The following characteristics are known in the art to be desirable qualities for electrode assemblies: compactness, configurability, low cost and simple construction.

Furthermore, it is important in some applications that an electrode assembly have resiliency in performance for a variety of environments, a tolerance for imperfections in assembly parts and scale easily in total power handling capacity. Furthermore, that it be easy to modify the electrode polarity, quantity of electrodes and electrode gap spacing. Still further, that the size footprint of the electrode assembly is minimized. Furthermore, that the parts are sourced easily at low cost and the construction is so simple that a lay person may fully assemble, disassemble, modify and repair the electrode assembly without special skills.

A burgeoning new interest in the field of water electrolysis is gaining in popularity; people have begun installing water decomposition apparatuses into their motor vehicle for purpose of detonating gas production and introduction to the air-fuel mixture of the engine in order to improve fuel efficiency.

One problem encountered in this application is that most modern vehicles have precious little spare space available within the engine compartment. Furthermore, the electrode assembly must be robust enough to withstand the constant vibration of the engine, stop-and-go motions and periodic jostles associated with a traveling motor vehicle. Furthermore, in such applications end users are usually lay persons and it is not uncommon that electrodes are handled without proper gloves or rinsing thus introducing oils and other impurities from the hands which produce foam and/or sludge during electrolytic operation requiring disassembly and cleaning.

It is known in U.S. Pat. No. 4,855,032 abstract section describes an easy and convenient quick release mechanism utilizing springs and clips making disassembly for cleaning simple. However such a mechanism would be unsuitable for placement in a motor vehicle due to the constant vibration and potential jostling, which would likely jar the electrode assembly loose.

It is further known in U.S. Pat. No. 0,092,593 on pg. 25 paragraph 13 an electrode assembly without the use of welds. While this simplifies the design and construction it is accomplished by one piece folds and thus it is not easy to reconfigure the spacing distance, number of electrodes or electrode polarity as may be required in some applications such as the aforementioned water decomposition apparatus placed on-board a motor vehicle.

Furthermore it is known by those skilled in the art that the amount of detonating gas produced in a water decomposition apparatus is affected by the amount of electrode surface area, current density and resistance of components and electrolyte. Therefore it is disadvantageous to reduce the surface area of electrodes by drilling holes, as is often done in the art, for the escaping of gases and/or movement of electrolyte and/or attaching of fasteners. It is also known by those skilled in the art that the exergy or quality of electricity to do work is diminished when electricity encounters obstructions such as holes in the planar electrode as shown in a typical filter press type cell in U.S. Pat. No. 6,828,057 FIG-4 drawing.

There is therefore a need to provide an improved electrode assembly suitable for a wide range of applications that overcomes these and various other prior art shortcomings and disadvantages.

### BRIEF SUMMARY OF THE INVENTION

The object of the present invention is to provide a streamlined electrode assembly for planar electrodes (hereinafter referred to simply as “electrodes”) that is compact, inexpensive, easily configured and easily constructed. Furthermore, the present invention improves upon the art by eliminating the need for drilling (or punching) holes in the electrodes as is often done in the art; this simplifies construction and maximizes electrode surface area eligible for use in electrolysis. The terms “conductive” and “insulating” as used herein should be construed to mean “electrically conductive” and “electrically insulating” respectively, unless otherwise noted.

In accordance with the present invention there is provided an electrode assembly formed by two or more rod subassemblies arranged to secure the electrodes equidistantly and provide power. Each rod subassembly comprises of a rod axially ringed, through their respective holes, by pairs of electrically conductive fasteners (hereinafter referred to as “conductive fasteners”), pairs of electrically insulating fasteners (hereinafter referred to as “insulating fasteners”), and distancing spacers. Each rod is terminated on the distal ends by securing end fasteners. The rod subassemblies are arranged orthogonal to the proximal electrode edges on at least one side of the electrodes.

The pairs of, conductive or insulating, fasteners are configured to have one fastener on each side of a portion of the proximal electrode edge. All pairs of, conductive or insulating, fasteners are separated along the rod axis by distancing spacers and axially ringed along the centerline major axis of the rod (hereinafter referred to as simply “the rod axis”). The rod subassembly is terminated on the distal rod ends by securing end fasteners, which lock the components together in compression and consequently clamp the proximal electrode edges in place.

At least one rod subassembly must be configured as a cathode charging bus and at least one other rod subassembly must be configured as an anode charging bus. An electrode is made monopolar by attaching at least one of its proximal edges to a charging bus of desired polarity by a pair of conductive fasteners and making all proximal edge attachments to rod subassemblies configured as charging buses of the undesired polarity by pairs of insulating fasteners. An electrode is made bipolar (or neutral) by making all proximal edge attachments to rod subassemblies configured as charging buses by pairs of insulating fasteners.

### BRIEF DESCRIPTION OF THE DRAWINGS

FIG. 1 is a side view of an embodiment of the present invention having two rod subassemblies.

FIG. 1A is a top view of FIG. 1.

FIG. 1B is a front perspective view from below of FIG. 1.

FIG. 2 is a horizontal perspective view from above of an embodiment of the present invention having four rod subassemblies.

FIG. 2A is a top view of FIG. 2.

### DETAILED DESCRIPTION OF THE INVENTION

The present invention will now be described more fully with reference to the accompanying drawings, which show specific embodiments. However, the present invention may be embodied in many different constructions and should not be construed as being limited to the specific embodiments shown in the drawings. Rather, the specific embodiments shown in the drawings are provided for completeness of the disclosure and to assist in fully conveying the present invention to those skilled in the art.

In the drawings, the width of distancing spacers is exaggerated in comparison to the distance between the electrodes and rods, for clarity. In preferred embodiments, the distance between the electrodes and rods is equal to or greater than the width of distancing spacers. Furthermore for clarity, common components in the drawings are not separately labeled; the conductive fasteners 5 are distinguished from insulating fasteners 4 by shading upon the annular edges.

The present invention provides an electrode assembly comprising of two or more rod subassemblies and a plurality of electrodes. The rod subassemblies are arranged on one or more sides of the electrodes, with the centerline major axis of the rods orthogonal to the proximal electrode edges, preferably arranged in symmetrically mirrored pairs equally spaced on opposite sides.

Each rod subassembly comprises of a rod (1, 2, 8, 9, 10, 11), pairs of conductive fasteners 5, pairs of insulating fasteners 4, distancing spacers 7 and securing end fasteners 6. Each pair of insulating or conductive fasteners overlaps a portion, on opposite sides of the proximal electrode edge, clamping the electrode in place when compressed.

Each rod subassembly acts as a frame, rigidly holding the components (4, 5, 7, 6) and optionally a charging bus. At least two rod subassemblies must be configured as charging buses to supply power to the electrodes, at least one configured as a cathode charging bus and at least one as an anode charging bus. The rod subassemblies serving as charging buses will be attached to a power supply (not shown) by a contact, boss or wire placed on the distal end of the rod and either secured inline with a securing end fastener 6 or with an additional fastener (not shown).

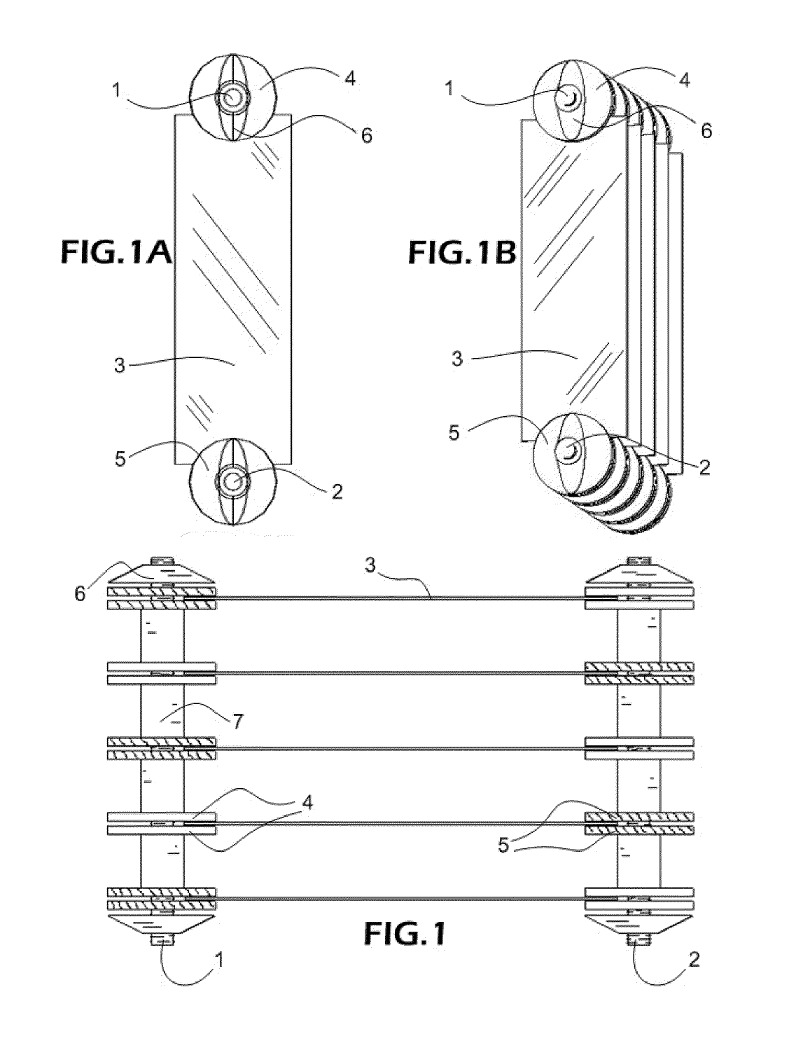

FIG. 1 shows a side view of a simple embodiment of the present invention having two rod subassemblies. Consequently both rods, per the present invention, must be configured as a charging bus of distinct polarity. For purposes of discussion, rod 1 will be considered the cathode charging bus and rod 2 the anode charging bus but are otherwise interchangeable.

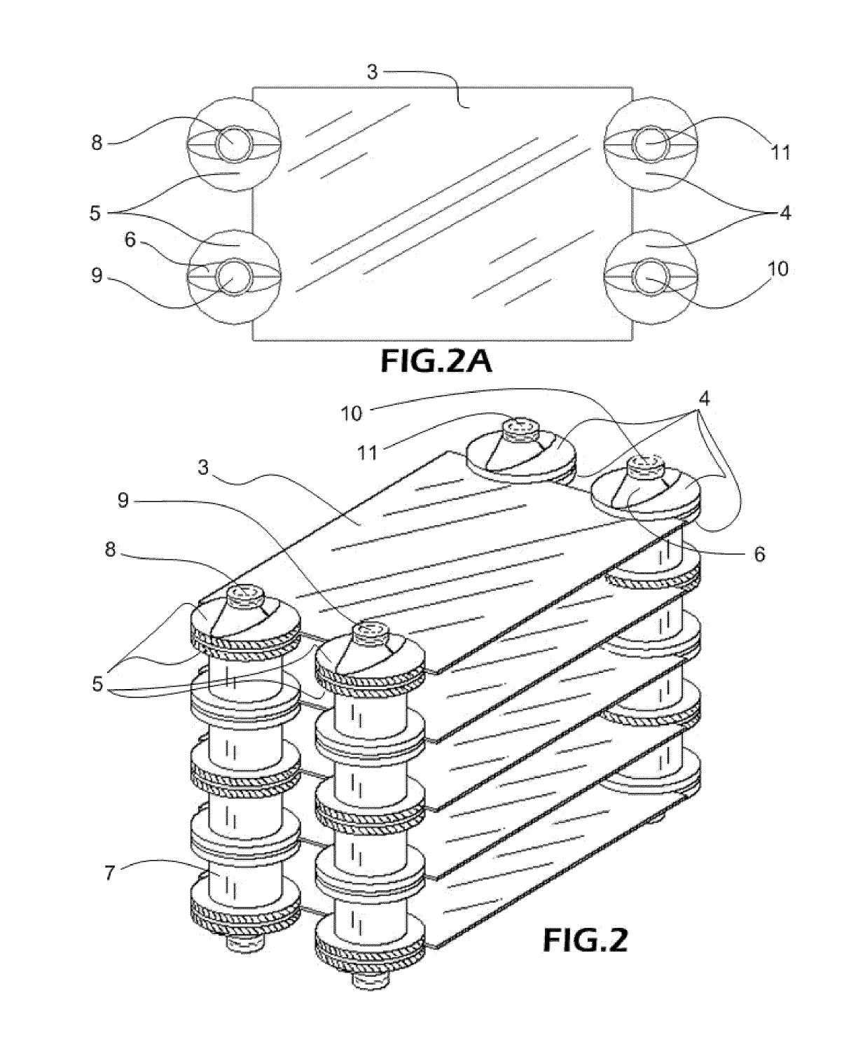

The rods 1, 2 may be made of any suitable electrically conductive material, a preferred material depends on the application and electrolyte used. For example, in a water decomposition apparatus using potassium hydroxide (KOH) as the electrolyte a preferred rod material is austenitic stainless steel (316L or 317L) for low cost, strength and corrosion resistance. A preferred diameter for rods is 0.25 inches but any diameter that provides efficient current carrying capability for the power requirements and enough strength to make the electrode assembly rigid is suitable. For embodiments having multiple rod subassemblies per attached electrode edge, as shown in FIG. 2, the rods not configured as charging buses may optionally be made of an insulating material, preferably polytetrafluoroethylene (hereinafter referred to as “Teflon”) or nylon for good electrical insulation, low cost and corrosion resistance. The rods may be smooth or threaded, for ease of construction threaded is preferred; if a smooth rod is used it is preferred that at least the ends be threaded for ease of construction in allowing the use of a common nut as the securing end fasteners 6. Otherwise, a smooth rod not threaded on the ends may use a screw clamp or other similar type fastener for the securing end fasteners 6. The rods should be of sufficient length to hold the pairs of electrode fasteners (4, 5), distancing spacers 7, securing end fasteners 6 and enough space for attachment to a power source (if the rod subassembly is a charging bus).

As shown in FIG. 1, a plurality of electrodes 3 are equidistantly spaced in parallel, situated orthogonal to the centerline major axis of the rods. The electrodes are held in place by pairs of fasteners (4, 5) which have at least one part residing on opposite sides of a portion of the proximal electrode edge, each fastener pair along the rod axis is separated by distancing spacers 7, all components are ringed axially, through their respective holes, along the rods 1, 2. The components 4, 5, 7, 3 are compressed together and locked in place by securing end fasteners 6, subsequently securing the proximal electrode edges.

The distancing spacers 7 can be of any size and shape provided they contain a hole, of a diameter sized approximate to the rod diameter, such that it fits axially ringed around the rod and contacts the electrode fastener pairs (4, 5), and preferably be made of an insulating material of sufficient strength to withstand compression (of approximately hand tightened) and not deform or break (for example, Teflon or nylon). The spacers shown in FIGS. 1, 2 are of standoff type but can easily be swapped for other types (for example, washers preferably made of Teflon). Furthermore, the distancing spacers may consist of various types used alone or in combination such that they provide equal distancing (for example, one 5 mm standoff may be combined with five 1 mm washers). Moreover, the term “distancing spacer” should be construed to mean any singular or combination of any type of spacer which suffices to create a gap of equal distance between electrodes.

The fasteners 4, 5 may be of any shape and size provided they contain a hole of diameter sufficient to snugly fit axially upon the rods and a width large enough to allow sufficient electrode surface area contact, for the amount of current to be supplied (if any), while maintaining a distance between rod and the proximal electrode edge that is equal to or greater than the distance spacing (as dictated by width of distancing spacers 7) between individual electrodes (not as shown). For the conductive fasteners 5, is preferred to use fender washers (oversized washers) made of the same material chosen for the conductive rods (1, 2) for low cost and to use fender washers made of Teflon or nylon for the insulating fasteners 4 for good electrical insulation, low cost and corrosion resistance. Furthermore, the fastener pairs (4, 5) may consist of one or more fastener parts per pair side if desired (for example, to provide ease of creating uniform gaps between electrodes by closing the distance between fastener pairs along the rod axis). Moreover, the term “fastener pair”, “pair of fasteners”, “pairs of insulating fasteners”, “pairs of conductive fasteners” or any reference to the components 4, 5 of the drawings should be construed to include all possible types and combinations for the component as described.

The securing end fasteners 6 may be of any type which fit the rod and securely hold the arrangement of axially situated components in compression. If the rod is threaded at least on the ends it is preferred that a nut (either hex or wing nut type) of diameter and thread to match the rod be used, preferably made of a strong and corrosion resistant material such as austenitic stainless steel (316L or 317L). The securing end fasteners are referred to in singular form but may be any combination of one or more types if desired, thus any use of the term “securing end fastener”, “securing fastener”, “end fastener” or reference to 6 in the drawings should be construed to mean any and all possible combinations and types for the component as described.

In the embodiment shown in FIG. 1 each electrode has been made monopolar, by means of attaching the electrode on one rod side by a pair of conductive fasteners 5 and on the opposite rod side by a pair of insulating fasteners 4. Each electrode is configured such that each adjacent electrode is of the opposite polarity. For example, the top electrode in FIG. 1 is provided a negative charge since it is attached to rod 1 by conductive fasteners 5 and attached to rod 2 by insulating fasteners 4. Likewise, the second electrode from the top in FIG. 1 is provided a positive charge since it is attached to rod 1 by insulating fasteners 4 and attached to the rod 2 by conductive fasteners 5.

A negative polarity electrode is obtained by attaching at least one proximal electrode edge to an cathode charging bus (for example 1) by means of conductive fasteners 5 and making all proximal electrode edge attachments to anode charging buses (for example 2) by means of insulating fasteners 4.

A positive polarity electrode is obtained by attaching at least one proximal electrode edge to an anode charging bus (for example 2) by means of conductive fasteners 5 and making all proximal electrode edge attachments to cathode charging buses (for example 1) by means of insulating fasteners 4.

A bipolar or neutral electrode is obtained by attaching all proximal electrode edges to all rod subassemblies that are configured as charging buses by means of insulating fasteners 4 (not shown). The fastener pairs attaching the electrode to unpowered rod subassemblies may be of conductive or insulating type, preferably insulating and made of Teflon.

There are several advantages to having multiple rod subassemblies on the same electrode edge side, an example of which is shown in FIG. 2. One advantage is that larger sized electrodes may be used while maintaining structural rigidity. Another advantage is that multiple rod subassemblies may power a single electrode (for the same polarity) allowing more current than would otherwise be efficiently tolerated for a single similarly sized rod subassembly. Another advantage is that it is possible to keep all charging buses along a single electrode edge side which simplifies electrical connections within the electrolytic cell housing. Furthermore, connections in embodiments having multiple rod subassemblies configured as charging buses of a given polarity can be simplified by powering the charge buses in series (daisy-chained) thus reducing the amount of direct electrical connections to the power source. It is also preferred for rigidity that at least one rod subassembly is added and positioned for every 4 inches of electrode edge, on the longer sides for polygonal shaped electrodes, on at least two symmetrically opposite electrode sides.

An embodiment comprising of four rod subassemblies is illustrated in FIGS. 2, 2A and, as per the present invention, at least two rod subassemblies must be configured as charging buses (one as anode and one as cathode). In the configuration of FIG. 2 the arrangement of fastener pairs (4, 5) match at each corresponding electrode pair on the rods (8, 9) and (10, 11) respectively as shown. Thus in this case the anode or cathode charging buses must reside on the same side (for example, 8 and/or 9 must be configured as either a cathode or anode charging bus exclusively, and 10 and/or 11 must be configured as a charging bus of polarity opposite that of 8 and/or 9).

Other embodiments for the present invention are possible which are not shown in the drawings. For example, rod subassemblies may be positioned at one or more electrode edges up to and including rod subassemblies being placed on all electrode edge sides for greater stability and/or higher power while maintaining smaller subcomponents than would otherwise be possible. Furthermore, although according to the present invention the electrodes must be planar they can be of any shape (for example, polygonal or elliptical) and size provided they have sufficient edge area for attachment to the rod subassemblies. Depending upon the shape of the electrodes a number of alternate arrangements are preferred. For example, if the electrodes are triangular it is preferred to have a rod subassembly on each of the three electrode edge sides for rigidity. For another example, if the electrodes are elliptical having a major axis diameter of 6 inches or less it would be preferred to have two rod subassemblies on opposite sides across the major axis. Furthermore, if the electrodes are circular and of jumbo size it is preferred to have at least one rod subassembly roughly 4 inches apart evenly spaced along the electrode edge.

The invention has thus been described using example embodiments and explanations of preferred configurations and materials. However, it is to be understood that the scope of the invention is intended to include various alternate constructions, materials and combinations thereof.

What I claim is:

1. A rod subassembly, to be used as an electrode frame component and as a charging bus, comprising:
a conductive rod;
securing end fasteners; and
the following components, each having a hole of a size slightly larger than the rod diameter such that the components may be easily ringed onto the major axis of the rod:
distancing spacers;
at least one pair of conductive fasteners; and
at least one pair of insulating fasteners.

2. A rod subassembly, used as an electrode frame component only, comprising:
an insulating or conductive rod;
securing end fasteners; and
the following components, each having a hole slightly larger than the rod diameter such that the components may be easily ringed onto the major axis of the rod:
distancing spacers; and
pairs of, insulating and/or conductive, fasteners.

4. A method of constructing a rod subassembly from its components, comprising steps of:
affixing a securing end fastener to a distal rod end;
adding the components onto the rod by sliding the individual components from the open distal rod end through their respective holes onto the axis of the rod, adding at least one pair of fasteners for each electrode in the assembly with a distancing spacer placed in-between, thus separating each pair of insulating or conductive fasteners from one another; and
loosely terminating the open distal rod end by another securing end fastener.

5. A method of forming the electrode assembly from rod subassemblies, comprising steps of:
firstly, the rod subassemblies are arranged along the proximal electrode edges where they are to be attached, oriented such that the expected corresponding fastener pairs between rod subassemblies are aligned and sufficiently spaced apart to allow proximal electrode edges to be easily fitted between the pairs of fasteners on each rod subassembly;
for rod subassemblies that are charging buses, it is recommended that the electrodes are manually spaced equidistantly away from the conductive rods to a distance equal to or greater than the width of the distancing spacers;
positioned to any desired location along the proximal electrode edge, the securing end fasteners are then tightened, making all components rigid;
at least one rod subassembly configured to be an anode charging bus by attaching the distal end of its conductive rod to a positive power source; and
at least one rod subassembly configured to be a cathode charging bus by attaching the distal end of its conductive rod to a negative power source.

6. A planar electrode assembly, comprising:
a plurality of planar electrodes;
at least two rod subassemblies of claim 1;
zero or more rod subassemblies of claim 2; and
each said rod subassembly is formed by the method as described in claim 4, wherein:
the step of adding pairs of conductive fasteners and pairs of insulating fasteners separated by distancing spacers is done such that any electrode edge attached to a rod subassembly configured as a charging bus by a pair of conductive fasteners has all other proximal electrode edge attachments to rod subassemblies configured as charging buses of opposite polarity by means of insulating fasteners, at least one electrode is provided a negative monopolar charge and at least one electrode is provided a positive monopolar charge, electrode plates are made monopolar by adding fastener pairs such that amongst all corresponding fastener pairs on each of the rod subassemblies for the given electrode at least one pair of fasteners connecting the said electrode edge to a charging bus of the desired polarity is made to be conductive, while all fastener pairs attaching said electrode to charging buses of the undesired polarity are made by pairs of insulating fasteners, zero or more bipolar or neutral electrodes are added if desired by making all connections to rod subassemblies configured as charging buses by pairs of insulating fasteners; and
the rod subassemblies and electrodes are formed into a fully constructed electrode assembly as described in claim 5.
